(19) United States
(12) Patent Application Publication
(10) Pub. No.: US 2026/0209525 A1
(43) Pub. Date: Jul. 23, 2026

(54) THERMOPLASTIC POLYMER POWDER HAVING A LARGE PARTICLE SIZE DISTRIBUTION

(71) Applicant: ARKEMA FRANCE, Puteaux (FR)

(72) Inventors: Denis HUZE, Serquigny (FR); Alexis MORFIN, Serquigny (FR)

(73) Assignee: ARKEMA FRANCE, Puteaux (FR)

(21) Appl. No.: 19/140,586

(22) PCT Filed: Dec. 22, 2023
(86) PCT No.: PCT/EP2023/087573

§ 371 Date: Jun. 18, 2025

(30) Foreign Application Priority Data
Dec. 26, 2022 (FR) FR2214493

(51) Int. Cl. C09D 5/03; B29C 41/04; B29K 77/00; B29K 105/00; B33Y 70/00; C08J 3/12; C08J 3/14; C08L 77/00; C09D 7/61; C09D 7/65; C09D 7/80; C09D 177/00

(52) U.S. Cl. CPC C09D 5/031; B33Y 70/00; C08J 3/126; C08J 3/128; C08J 3/14; C08L 77/00; C09D 7/61; C09D 7/65; C09D 7/80; C09D 177/00; B29C 41/04; B29K 2077/00; B29K 2105/251; C08J 2377/00; C08L 2203/30; C08L 2207/53

(57) ABSTRACT

The invention relates to a thermoplastic polymer powder having a Hausner ratio of less than or equal to 1.30 and comprising particles having a particle size distribution characterized by a span of greater than or equal to 1.0.

The invention also relates to the use of such a powder for constructing a three-dimensional article, for coating a surface and for manufacturing an article by rotational molding. The invention also relates to a process for preparing a thermoplastic polymer powder, and also to a process for encapsulating thermoplastic polymer particles with at least one additive.

### FIELD OF THE INVENTION

The present invention relates to a thermoplastic polymer powder, to the use thereof in a process for constructing a three-dimensional article, for coating or for rotational molding, and also to an article manufactured therefrom. The invention also relates to a process for preparing a thermoplastic polymer powder, and also to a process for encapsulating thermoplastic polymer particles with at least one additive.

### TECHNICAL BACKGROUND

The construction of three-dimensional (3D) articles may be used to produce prototypes or various parts, for example in the automotive, nautical, aeronautical, aerospace, medical (notably for the manufacture of prostheses, hearing systems, cell tissues, etc.), textile, clothing, fashion, decoration, electronic housing, telephony, home automation, computer, lighting, sport and industrial tool sectors.

Among the techniques for the manufacture of 3D articles, the process of manufacture by sintering is particularly advantageous. According to this process, a layer of polymer powder is, conventionally, selectively and briefly irradiated in a chamber with electromagnetic radiation (for example laser beam, infrared radiation, UV radiation), the result being that the powder particles impacted by the radiation melt. The molten particles coalesce and solidify to result in the formation of a solid mass. This process can produce, in a simple way, 3D articles by repeated irradiation of a succession of freshly applied layers of powder.

The polymer powders used in the processes for manufacturing 3D articles layer-by-layer are often produced by a grinding process, which leads to particles of very varied and angular shapes and generally with a broad particle size distribution.

Due to these irregular shapes and the presence of sharp angles and protruding edges in the particles, the powders produced by grinding have a relatively low degree of packing (characterized by a high Hausner ratio), resulting in reduced pourability (or free-flowability) and a reduced powder spreading capacity, and can therefore hinder the use of the polymer powder in the processes for manufacturing 3D articles in particular by sintering. Specifically, problems with the free flow of the powder lead to a risk of creating voids when stacking the particles to form an object (in particular by selective laser sintering or SLS). In addition, poor free flow of the powder can lead to surface appearance defects (aggregates, powder flow line) in other technologies such as rotational molding, fluidized bed dip coating or electrostatic spraying.

Moreover, grinding very often gives rise to the creation of fibrils or short fibers that disrupt flow and spreading. In the case of a process for manufacturing 3D articles, these particles, due to their particular shape, are often the cause of appearance defects on the parts produced if they are situated on the edges of the parts to be constructed. Moreover, during the transfer of powder, these fibers or fibrils tend to combine with one another to form balls which are sources of defects in the majority of powder processing processes.

Lastly, a ground powder often has a larger developed surface area than a powder obtained by dissolution/precipitation, which is often more spherical and therefore has a smaller developed surface area. The latter powder will require, in the case of dry mixing, fewer additives (e.g. flow agents) to achieve the same flow capacity.

Alternatively, the powders may be produced by a dissolution/precipitation process. However, such a process typically results in a powder comprising monodisperse particles (i.e. having a narrow particle size distribution), which can lead to poor coalescence of the particles when the powder is used (for example, in 3D printing or in surface coating or molding processes). Specifically, unlike a monodisperse system, a broad particle size distribution allows the finest particles of this distribution to fit between the largest ones and to thus minimize inter-particle voids.

Moreover, powders with a low span (i.e. narrow particle size distribution) often exhibit high flows (starting from certain particle sizes depending on the material of the powder). This “fluid” character of the flow can negatively affect the good spreading of the SLS powder layer via the formation of a wave in front of the doctor blade or levelling roller. In rotational molding, a high powder fluidity often generates parts with poorly controlled thicknesses, mainly in the concave areas of the mold (due to centrifugation). The use of a low-span powder in rotational molding is also not favorable for the following reason: a broad particle size distribution allows the film lining the mold to build up gradually. Specifically, since the finer particles reach their softening (or melting) temperature before the larger particles, the coating builds up progressively from the wall of the mold towards the inner face of the part, thus avoiding the creation of porosities.

One example of powder for 3D printing applications is described in the document US 2021/0130608. This document relates to a biocompatible polymer powder intended in particular for use in the 3D printing of medical devices, comprising in particular a bioceramic as flow agent.

There is therefore a real need to provide polymer powders exhibiting better pourability and better spreading and allowing the manufacture, especially when used for the construction of 3D articles, objects that are less porous and more rigid and have a smoother surface.

### SUMMARY OF THE INVENTION

The invention firstly relates to a thermoplastic polymer powder having a Hausner ratio of less than or equal to 1.30 and comprising particles having a particle size distribution characterized by a span of greater than or equal to 1.0.

In some embodiments, the thermoplastic polymer is a semicrystalline thermoplastic polymer.

In some embodiments, the thermoplastic polymer is chosen from the group consisting of polyamides, vinylidene fluoride homopolymers and copolymers, copolymers containing polyamide blocks and polyether blocks, thermoplastic polyurethanes, copolymers containing polyester blocks and polyether blocks, polycarbonate, polystyrene, polyaryl ether ketones, polyolefins, and combinations thereof.

In some embodiments, the thermoplastic polymer is at least one polyamide, preferably a polyamide 11, a polyamide 12 and/or a polyamide 6, and/or a copolymer containing polyamide blocks and polyether blocks, wherein preferably the polyamide blocks are polyamide 6, polyamide 11, polyamide 12, polyamide 6.10, polyamide 10.10 and/or polyamide 10.12 blocks and the polyether blocks are blocks derived from polyethylene glycol, propylene glycol, polytrimethylene glycol and/or polytetrahydrofuran.

In some embodiments, the powder has a Hausner ratio of less than or equal to 1.28, preferably of less than or equal to 1.20, more preferably of less than or equal to 1.15.

In some embodiments, the powder comprises particles having a particle size distribution characterized by a span of 1.0 to 2.5, preferably of 1.0 to 2.0.

In some embodiments, the powder comprises at least one additive, preferably chosen from the group consisting of flow agents, mineral fillers, fibers, polymer powders, dyes, pigments, fireproofing additives, antioxygen stabilizers, light stabilizers, impact modifiers, antistatic agents, flame retardants, and mixtures thereof.

The invention also relates to the use of a powder as described above for constructing a three-dimensional article, preferably layer-by-layer, more preferentially by sintering, even more preferentially by electromagnetic radiation-mediated sintering.

The invention also relates to the use of a powder as described above for coating a surface, preferably a metallic surface.

The invention also relates to the use of a powder as described above for manufacturing an article by rotational molding.

The invention also relates to a process for preparing a thermoplastic polymer powder, comprising the following steps:
a) providing a thermoplastic polymer powder;
b) heating said powder by means of an energy source with a temperature of from 600 to 10 000° C., preferably from 600 to 8000° C., more preferentially from 1000 to 3000° C.;
c) preferably, spraying the powder;
d) cooling the powder; and
e) collecting the powder.

In some embodiments, the powder prepared is a powder as defined above.

In some embodiments, the step of providing the thermoplastic polymer powder comprises grinding the thermoplastic polymer, or dissolving the thermoplastic polymer in a solvent and precipitating said thermoplastic polymer from the solvent.

The invention also relates to a process for encapsulating thermoplastic polymer particles with at least one additive, comprising the following steps:
a) providing thermoplastic polymer particles;
b) mixing the thermoplastic polymer particles with at least one additive, preferably chosen from the group consisting of flow agents, mineral fillers, fibers, polymer powders, dyes, pigments, fireproofing additives, antioxygen stabilizers, light stabilizers, impact modifiers, antistatic agents, flame retardants, and mixtures thereof, so as to form a thermoplastic polymer powder;
c) heating said powder by means of an energy source with a temperature of from 600 to 10 000° C., preferably from 600 to 8000° C., more preferentially from 1000 to 3000° C.;
d) spraying the powder, where appropriate;
e) cooling the powder; and
f) collecting the powder.

In some embodiments, the step of providing thermoplastic polymer particles comprises grinding the thermoplastic polymer, or dissolving the thermoplastic polymer in a solvent and precipitating said thermoplastic polymer from the solvent.

In some embodiments, the cooling is carried out by bringing the powder into contact with a cold gas, preferably compressed air, or cold water.

In some embodiments, the powder is collected in a recovery tank or in a cyclone.

In some embodiments, the process further comprises a step of screening the collected powder and/or a step of mixing the collected, and optionally screened, powder with at least one additive, preferably chosen from the group consisting of flow agents, mineral fillers, fibers, polymer powders, dyes, pigments, fireproofing additives, antioxygen stabilizers, light stabilizers, impact modifiers, antistatic agents, flame retardants, and mixtures thereof.

The invention also relates to a three-dimensional article manufactured from a powder as described above or from a composition as described above, preferably by layer-by-layer printing, more preferentially by sintering.

The present invention makes it possible to meet the need expressed above. It more particularly provides a thermoplastic polymer powder exhibiting higher pourability, better spreading capacity and improved coalescence ability during the use thereof. Moreover, when the powder is used for the construction of three-dimensional objects, such as by a sintering process, it makes it possible to obtain objects having a smoother and more homogeneous surface, which makes it possible in particular to facilitate subsequent treatments of the surface of said objects, and having a higher density, and therefore good mechanical properties, in particular higher rigidity. The powder according to the invention also allows a good stacking of the particles, which ensures good dimensional stability of the successive deposited layers and thus good holding of the parts under construction. In addition, the powder according to the invention has improved thermal stability, which makes it possible to improve the recyclability of the powder in other construction processes.

This is accomplished by virtue of a powder having both a low Hausner ratio, reflecting a high untapped density of the powder compared to its tapped density, while at the same time having a relatively broad particle size distribution (high span).

The invention also provides a process for preparing a thermoplastic polymer powder making it possible to obtain a powder having both a broad particle size distribution (high span) and a high flowability (low Hausner ratio). In addition, the process according to the invention makes it possible to remove at least a portion of the very fine particles, which may in particular be responsible for fouling 3D printing or rotational molding devices when the powder is used and which are difficult to remove by other selection processes such as screening.

This is accomplished by virtue of the application of a powder treatment comprising a step of heating by means of an energy source with a temperature of from 600 to 10 000° C. followed by cooling.

The invention also provides a process for encapsulating thermoplastic polymer particles with at least one additive, which enables a homogeneous distribution of the additive in the powder to be maintained over time and is capable of reducing the coalescence of the particles. In particular embodiments in which the additive comprises fibers, the process according to the invention makes it possible to maintain the random orientation of the fibers over time and thus maintain the isotropic properties of the powder.

### BRIEF DESCRIPTION OF THE FIGURES

FIG. 1 represents a micrograph obtained by scanning electron microscopy (SEM, magnification ×160) of the powder no. 1′ as described in example 1 below.

FIG. 2 represents a micrograph obtained by scanning electron microscopy (magnification ×160) of the powder no. A′ as described in example 1 below.

FIG. 3 represents a micrograph obtained by scanning electron microscopy (magnification ×160) of the powder no. 2′ as described in example 1 below.

FIG. 4 represents a micrograph obtained by scanning electron microscopy (magnification ×160) of the powder no. B′ as described in example 1 below.

FIG. 5 represents a micrograph obtained by scanning electron microscopy (magnification ×160) of the powder no. C′ as described in example 1 below.

### DETAILED DESCRIPTION

The invention will now be described in greater detail and non-limitingly in the description that follows.

Unless otherwise indicated, all the percentages concerning amounts are mass percentages.

In the present text, the amounts indicated for a given species may apply to that species according to all its definitions (as mentioned in the present text), including the more restricted definitions.

### Powder

The invention relates to a thermoplastic polymer powder. The term “thermoplastic polymer powder” is understood to mean a powder comprising at least particles comprising at least one thermoplastic polymer; for the purposes of the present invention, the “thermoplastic polymer powder” may thus comprise components other than a thermoplastic polymer (in particles comprising the thermoplastic polymer or in particles devoid of thermoplastic polymer), for example additives.

The thermoplastic polymer may be semicrystalline or amorphous, and is preferably semicrystalline.

The term “semicrystalline thermoplastic polymer” is understood to mean a thermoplastic polymer having:
a) a crystallization temperature (Tc), which is determined according to the standard ISO 11357-3:2013, during the step of cooling at a rate of 20 K/min in DSC (differential scanning calorimetry);
b) a melting temperature (Tm), which is determined according to the standard ISO 11357-3:2013, during the step of heating at a rate of 20 K/min in DSC; and
c) an enthalpy of fusion (ΔHf), determined according to the standard ISO 11357-3:2013, during the step of heating at a rate of 20 K/min in DSC, which is greater than 5 J/g, preferably greater than 10 J/g, for example greater than 20 J/g, and is generally less than 200 J/g, preferably less than 150 J/g, for example less than 100 J/g, or less than 50 J/g.

Advantageously, the semicrystalline thermoplastic polymer has a melting temperature Tm of 100 to 300° C., and preferably of 120 to 200° C. The Tm is measured as indicated above, and corresponds to the Tm measured during the first heating.

The semicrystalline thermoplastic polymer may have a crystallization temperature Tc of 40 to 250° C., preferably of 45 to 200° C., for example of 45 to 150° C.

The Tc is measured as indicated above.

Typically, the Tm and the Tc are determined directly from the semicrystalline thermoplastic polymer powder. When the powder is a mixture of polymers, the Tm is understood to mean the lowest melting temperature of the mixture of polymers and the Tc is understood to mean the highest temperature of the mixture of polymers.

Preferably, the thermoplastic polymer is chosen from the group consisting of polyamides (PAs), vinylidene fluoride homopolymers and copolymers (PVDFs), copolymers containing polyamide blocks and polyether blocks (PEBAs), thermoplastic polyurethanes (TPUs), copolymers containing polyester blocks and polyether blocks (COPEs), polycarbonate (PC), polystyrene (PS), polyaryl ether ketones, such as polyether ether ketone (PEEK), polyolefins, such as polyethylene and polypropylene, and combinations thereof.

The thermoplastic polymer according to the invention may thus comprise, or be, at least one polyamide. It may be a homopolyamide or a copolyamide, or also a mixture of these.

In some embodiments, the thermoplastic polymer may in particular be an elastomeric thermoplastic polymer, more particularly chosen from a PEBA copolymer, a TPU and/or a COPE copolymer.

Of course, the name PEBA in the present description of the invention relates, in particular, just as well to the Pebax® products sold by Arkema, to the Vestamid® products sold by Evonik® and to the Grilamid® products sold by EMS, as to the PEBA products of Pelestat® type sold by Sanyo or to any other PEBA product from other suppliers.

In some embodiments, the elastomeric thermoplastic polymer may also be chosen from copolymers containing styrene blocks (TPSs), thermoplastic polyolefin elastomers (TPOs), and/or thermoplastic vulcanizates (TPVs). Examples of commercial elastomeric thermoplastic polymers are, for example, the products Cawiton®, Thermolast K®, Thermolast M®, Sofprene®, Dryflex® and Laprene® (TPSs), Desmopan® or Elastollan® (TPUs), Santoprene®, Termoton®, Solprene®, Thermolast V®, Vegaprene®, or Forprene® (TPVs), and For-Tec E® or Engage, Ninjaflex® (TPOs).

In some embodiments, the thermoplastic polymer comprises or is a polymer chosen from polyoxymethylene (POM) homopolymers and copolymers, polyethylene (PE), polypropylene (PP), polyethylene terephthalate (PET), polybutylene terephthalate (PBT), polyphthalamides (PPAs) and poly(p-phenylene terephthalamide), and mixtures thereof.

In some embodiments, the thermoplastic polymer may comprise, or be, a polycarbonate (PC).

In some embodiments, the thermoplastic polymer may comprise, or be, a polystyrene (PS).

In some embodiments, the thermoplastic polymer may comprise, or be, a polyether ether ketone (PEEK).

The thermoplastic polymer may consist of a single polymer, in particular as described above, or may comprise or consist of a mixture of (preferably semicrystalline) thermoplastic polymers, in particular a mixture of any of the (preferably semicrystalline) thermoplastic polymers as described above.

The thermoplastic polymer powder according to the invention has a Hausner ratio of less than or equal to 1.30. As is known, the Hausner ratio of a powder is defined as being the ratio of the tapped density of the powder to its untapped density (also called aerated density or apparent density). The tapped and aerated densities can be measured according to the standard ISO 3953:2011, for example using a STAV II tamping volumeter. Advantageously, the thermoplastic polymer powder has a Hausner ratio of less than or equal to 1.28, preferably less than or equal to 1.25, more preferably less than or equal to 1.20, more preferably less than or equal to 1.15, more preferably less than or equal to 1.12, more preferably less than or equal to 1.10.

In some embodiments, the powder has a Hausner ratio of less than or equal to 1.07, or less than or equal to 1.05, or less than or equal to 1.02, or a Hausner ratio of 1.0 to 1.05, or of 1.05 to 1.10, or of 1.10 to 1.15, or of 1.15 to 1.20, or of 1.20 to 1.22, or of 1.22 to 1.25, or of 1.25 to 1.28, or of 1.28 to 1.30. The lower the Hausner ratio of the powder, the better its pourability (or free flow) will be.

The thermoplastic polymer powder according to the invention is characterized by a span of greater than or equal to 1. The span parameter defines the particle size distribution of the particles of the powder and is calculated in a known manner by the following formula: span=(Dv90−Dv10)/Dv50, in which:
Dv90 denotes the particle size at the 90^{th} percentile, by volume, of the cumulative particle size distribution (in other words, it is the corresponding diameter for the cumulative function of the particle diameters, weighted by volume, to be equal to 90%),
Dv10 denotes the particle size at the 10^{th} percentile, by volume, of the cumulative particle size distribution (in other words, it is the corresponding diameter for the cumulative function of the particle diameters, weighted by volume, to be equal to 10%), and
Dv50 is the median diameter by volume of the particles and corresponds to the particle size at the 50^{th} percentile, by volume, of the cumulative particle size distribution.

The Dv50, Dv90 and Dv10 can be measured by laser diffraction particle size analysis according to the standard ISO 13320:2009, for example on a Malvern Insitec® diffractometer.

Preferably, the span of the particles of the powder is from 1.0 to 2.5, more preferentially still from 1.0 to 2.0 and more preferentially still from 1.2 to 2.0. In particular, the particles of the powder may have a span of 1.0 to 1.2, or of 1.2 to 1.5, or of 1.5 to 1.7, or of 1.7 to 2.0, or of 2.0 to 2.2, or of 2.2 to 2.5.

Preferably, the particles of the powder have a Dv50 of 20 to 500 μm, more preferentially of 30 to 250 μm, more preferentially still of 40 to 120 μm.

Preferably, the particles of the powder have a Dv90 of 50 to 800 μm, more preferentially of 60 to 500 μm, more preferentially still of 70 to 130 μm.

Preferably, the particles of the powder have a Dv10 of 5 to 100 μm, more preferentially of 10 to 80 μm, more preferentially still of 15 to 60 μm.

In some embodiments, the powder contains a cumulative fraction of particles with a size of less than or equal to 10 μm of less than or equal to 1% by weight, preferably less than or equal to 0.8% by weight, relative to the total weight of the powder.

In some embodiments, the powder contains a cumulative fraction of particles with a size of less than or equal to 30 μm of less than or equal to 10% by weight, preferably less than or equal to 5% by weight, more preferentially still less than or equal to 2% by weight, or less than or equal to 1% by weight, relative to the total weight of the powder.

The cumulative fraction of the particles is measured according to the standard ISO 13320:2009.

For the purposes of the present invention, the size of a particle means the mean volume equivalent diameter of said particle.

A powder containing a small cumulative fraction of the fine particles (in particular particles with a size of less than or equal to 30 μm, preferably less than or equal to 10 μm) as defined above has certain advantages for 3D printing or rotational molding processes because these fine particles can in particular be responsible for the fouling of 3D printing or rotational molding devices when the powder is used and be difficult to remove by other selection processes such as screening.

In some embodiments, the powder according to the invention consists, or essentially consists, of the at least one thermoplastic polymer.

The powder may additionally comprise one or more additives. Preferably, the powder may comprise one or more additives chosen from the group consisting of flow agents, mineral fillers, fibers, polymer powders, dyes, pigments, fireproofing additives, antioxygen stabilizers, light stabilizers, impact modifiers, antistatic agents, flame retardants, and mixtures thereof.

The powder may comprise at least one flow agent. The term “flow agent” is understood to mean an agent which makes it possible to improve the pourability and also the leveling of the powder, in particular during a sintering process.

The flow agent may for example be chosen from: silicas, in particular precipitated silicas, hydrated silicas, vitreous silicas, fumed silicas and pyrogenic silicas, glassy oxides, in particular vitreous phosphates and vitreous borates, alumina, such as amorphous alumina, TiO₂, calcium silicates, magnesium silicates, such as talc, mica, kaolin, attapulgite, waxes, and mixtures thereof.

The flow agent may be present in the composition in an amount of less than or equal to 5% by weight, preferably less than or equal to 3% by weight, relative to the total weight of the composition. This amount of flow agent may more particularly be from 0.1% to 2.5%, preferably from 0.1% to 2%, more preferably from 0.5% to 2%, for example from 0.5% to 1.5%, relative to the total weight of the composition.

The flow agent is generally in the form of a powder, preferably with particles of substantially spherical shape. The flow agent in the composition may have particles having a volume median diameter (Dv50) of less than or equal to 20 μm, preferably of less than or equal to 15 μm, more preferentially of less than or equal to 10 μm, more preferentially still of less than or equal to 1 μm. For example, the median diameter Dv50 of the particles of the flow agent may be from 10 nm to 100 nm, from 100 nm to 1 μm, or from 1 μm to 20 μm.

Alternatively, the powder may be devoid of a flow agent, and in particular of a flow agent as described above.

The powder may comprise one or more mineral fillers, for example chosen from carbonate mineral fillers, in particular calcium carbonate, magnesium carbonate, dolomite and/or calcite, barium sulfate, calcium sulfate, dolomite, alumina hydrate, wollastonite, montmorillonite, zeolite, perlite, nanofillers (fillers of the order of a nanometer), such as nanoclays and/or carbon nanotubes, carbon black, glass fibers, carbon fibers, and combinations thereof.

The powder according to the invention may comprise organic additives such as, more particularly, powders of polymer(s) (other than the thermoplastic polymer), in particular those having a melting temperature that is greater than the maximum temperature experienced by the powder during its use (for example, during a process for constructing a 3D article layer-by-layer), especially those with a Young's modulus of greater than or equal to 1000 MPa.

In some embodiments, the powder is devoid of mineral fillers and/or (preferably and) organic additives, in particular devoid of polymer powder other than the thermoplastic polymer.

The powder may comprise the mineral fillers and the organic additives in an amount by mass of less than or equal to 60%, preferably less than or equal to 30%, more preferably less than or equal to 1%, relative to the total weight of the composition, for example in an amount by mass of 0.05% to 60%, preferably of 1% to 30%, preferably of 1% to 20%, preferably of 1% to 10%.

The powder of the invention may also comprise one or more additives chosen from dyes, pigments, in particular pigments for colouring and pigments for infrared absorption, fireproofing additives, antioxygen stabilizers, light stabilizers, impact modifiers, antistatic agents, flame retardants, and mixtures thereof. These additives are preferably in the form of a powder with a Dv50 of less than or equal to 20 μm.

These additives may be present in the composition in an amount by mass of 0.05% to 5%, relative to the total weight of the composition.

In some embodiments, the powder essentially consists, or consists, of particles constituted of thermoplastic polymer and one or more additives chosen from flow agents, mineral fillers, polymer powders, dyes, pigments, fireproofing additives, antioxygen stabilizers, light stabilizers, impact modifiers, antistatic agents, flame retardants, and mixtures thereof.

### Manufacturing Processes

The invention also relates to a process for preparing a thermoplastic polymer powder, in particular a thermoplastic polymer powder as described above.

The preparation process comprises providing a powder of the thermoplastic polymer and heating it by means of an energy source with a temperature of from 600 to 10 000° C., preferably a flame. For the purposes of the present invention, it should be understood that the temperature ranges indicated for the energy source characterize the temperature of the energy source itself (at its centre) and not the temperature of the heated powder particles. The use of such an energy source allows a very rapid heating of the particles by increasing the thermal conduction.

The step of providing the powder may comprise the manufacture of such a powder. The thermoplastic polymer powder provided may be obtained by any suitable means. Advantageously, the powder is obtained by grinding the thermoplastic polymer (which is, for example, in the form of pellets). In these embodiments, the thermoplastic polymer (or the mixture of thermoplastic polymers) is preferably melted beforehand (for example at a temperature of between 15° and 300° C.) and then ground after being solidified. The grinding can be carried out using any suitable grinding device, such as a pin mill, a hammer mill, a classifier mill or a fluidized bed air jet mill. Advantageously, the grinding is a cryogenic grinding. In this case, the thermoplastic polymer is, in a first stage, cooled to a temperature lower than its glass transition temperature, for example to a temperature 10 to 50° C. lower than the glass transition temperature of the thermoplastic polymer. Thus, the thermoplastic polymer may be cooled to a temperature of less than or equal to −10° C., preferably of less than or equal to −50° C., and more preferably of less than or equal to −80° C. The cooling of the thermoplastic polymer before grinding may be carried out for example using liquid nitrogen, or with liquid carbon dioxide, or with dry ice, or with liquid helium.

Alternatively, the powder provided may be obtained by a dissolution/precipitation process (in particular when the thermoplastic polymer is a polyamide and/or a PEBA). In these embodiments, the process comprises dissolving the thermoplastic polymer in a solvent and precipitating the thermoplastic polymer from the solvent. More particularly, the process may comprise the steps of bringing the thermoplastic polymer (for example in the form of pellets) into contact with a solvent in order to obtain a mixture; heating the mixture in order to dissolve the copolymer in the solvent; and cooling the mixture in order to obtain the precipitated polymer in the form of a powder. The solvent in which the thermoplastic polymer is dissolved may be chosen from ethanol, propanol, butanol, isopropanol, heptanol, formic acid, acetic acid, N-methylpyrrolidone, N-butylpyrrolidone, butyrolactam and/or caprolactam. The thermoplastic polymer may have a mass fraction in the solvent of 0.05 to 0.5; and preferably of 0.1 to 0.3. The heating of the thermoplastic polymer/solvent mixture may be carried out in particular at (or up to) a temperature of 100 to 160° C., and preferably of 120 to 150° C.; and/or have a duration of 1 to 6 hours, and preferably of 1 to 3 hours. Then, the mixture is cooled in order to bring about the crystallization and thus the precipitation of the copolymer in the form of a powder. This cooling may be carried out down to a temperature of greater than or equal to 50° C., for example a temperature in the range from 50 to 90° C.; and may be carried out at a rate of 10 to 100° C. per hour, preferably of 10 to 60° C. per hour. The dissolution/precipitation process may comprise a step of drying the thermoplastic polymer powder after cooling the mixture, for example carried out in an oven. The drying may be carried out at a temperature of 10 to 150° C., preferably of 25 to 85° C., and may be carried out under vacuum (in particular at a pressure of greater than 10 mbar, preferably greater than 50 mbar) or under atmospheric pressure.

Preferably, the powder provided is a powder obtained by grinding. This makes it possible to obtain powders with a higher span.

Whatever the process for manufacturing it, the powder may be subjected to a selection step, in particular carried out on a screen or by a dynamic selector.

The thermoplastic polymer powder provided is then subjected to the heating step. Preferably, the powder is heated by means of a torch or any other means making it possible to generate a flow of hot gas, more preferentially by means of a torch. Advantageously, the torch is an oxy-fuel torch (that is to say using dioxygen O₂ as oxidizer), more preferentially an oxy-propane torch (that is to say using dioxygen and propane as oxidizers), an oxy-butane torch (that is to say using dioxygen and butane as oxidizers) or an oxy-acetylene torch (that is to say using dioxygen and acetylene as oxidizers), even more preferentially an oxy-propane torch.

Very preferably, the process comprises a step of spraying the powder. Preferably, the steps of heating the powder and spraying the powder are partly simultaneous. In particular, they may be carried out using the same device.

Preferably, a flame spray-type device is used as a torch. Such a device makes it possible to spray the powder, advantageously transported by a carrier gas, in particular air, through the flame. It is possible, for example, to use a MiniSprayJet F311 FX model device from IBEDA. This self-contained equipment only requires a connection to the energy sources to be operational.

Advantageously, the process according to the invention makes it possible, by an appropriate regulation of the energy source (preferably the flame), to improve the particle size of the powder by eliminating by combustion at least some of the very fine particles (in particular, the particles with a size of less than or equal to 30 μm, preferably less than or equal to 10 μm), these very fine particles being difficult to remove by other selection processes such as screening. A significant presence of very fine particles (in particular, particles with a size of less than or equal to 30 μm, preferably less than or equal to 10 μm) can in certain processes cause fouling of the devices used, in particular SLS 3D printing devices and rotational molding devices.

Preferably, the energy source (preferably the flame) has a temperature of 600 to 8000° C., more preferably of 600 to 4000° C., preferably of 1000 to 3000° C. The energy source may in particular have a temperature of 600 to 800° C., or of 800 to 1000° C., or of 1000 to 1200° C., or of 1200 to 1500° C., or of 1500 to 1700° C., or of 1700 to 2000° C., or of 2000 to 2200° C., or of 2200 to 2500° C., or of 2500 to 2700° C., or of 2700 to 3000° C., or of 3000 to 3500° C., or of 3500 to 4000° C., or of 4000 to 6000° C., or of 6000 to 8000° C., or of 8000 to 10 000° C.

The time of contact between the powder and the energy source (preferably the flame) is advantageously between 0.01 s and 1 s, preferably between 0.02 s and 0.1 s, in particular, the time of contact between the powder and the flame may be from 0.01 to 0.02 s, or from 0.02 to 0.04 s, or from 0.04 to 0.06 s, or from 0.06 to 0.08 s, or from 0.08 to 0.1 s, or from 0.1 to 0.25 s, or 0.25 to 0.5 s, or 0.5 to 0.75 s, or 0.75 to 1 s.

The heating of the thermoplastic polymer powder by means of the energy source as defined above makes it possible to cause partial melting of the powder particles at their surface, leading to rounding, or even spheronization (that is to say complete rounding) of the powder particles. This results in a reduction in the Hausner ratio of the powder, and in an improvement in its pourability.

In general, during the manufacture of the powder, the Hausner ratio of the powder can be reduced by increasing the energy of the powder heating treatment (which enables the melting at the surface of the particles). This can be done for example:
by increasing the flow rate of powder sprayed;
by increasing the flow rate of carrier air (or gas);
by increasing the flow rate of oxidizer;
by increasing the flow rate of fuel;
by increasing the pressure of cooling air (or gas);
by increasing the heating time of the particles by increasing the distance between the energy source (for example the sprayer) and the collecting device.

The process according to the invention furthermore has the advantage of hardly, if at all, reducing the span of the starting powder, which makes it possible to obtain powders having a span of greater than or equal to 1.00.

The carrier gas flow rate may be from 0 to 0.08 MPa, in particular from 0 to 0.05 MPa.

The oxidizer flow rate may be from 15 to 70 I/min, in particular from 20 to 60 I/min.

The fuel flow rate may be from 10 to 40 I/min, in particular from 15 to 25 I/min.

The pressure of the cooling gas may be from 0.15 to 0.8 MPa, in particular from 0.2 to 0.6 MPa.

Very preferably, the powder is then cooled. Preferably, the powder may be cooled by bringing it into contact with a fluid, in particular a cold gas and/or a cold liquid. The term “cold gas” is understood for the purposes of the present invention, to be a gas having a temperature of at most 30° C., and the term “cold liquid” is understood for the purposes of the present invention to be a liquid having a temperature of at most 20° C. The cold gas is more preferentially air, and more particularly compressed air. The cold liquid is advantageously water.

The preparation process preferably comprises a step of collecting the powder. Advantageously, the collection of the powder takes place at least in part simultaneously with its cooling. The collection of the powder very preferably comprises bringing the powder into contact with a fluid (gas and/or liquid), in particular the fluid used to cool the powder. The fluid, and in particular when it is a gas, can be in motion so as to entrain the powder particles, for example rotational motion. Bringing the powder into contact with a fluid (in particular in motion) makes it possible to reduce the agglomeration of the powder particles that can occur before they have finished cooling down.

The collection of the powder may be carried out in an appropriate collection device, such as a collection tank or, preferably, an appropriate cyclone. The use of a cyclone is particularly advantageous because it makes it possible to separate the powder particles from the carrier gas (the particles being collected at one end of the device while the powder carrier gas is discharged at another end of the device.

Compared to a recovery tank, the use of a cyclone makes it possible to reduce product losses and therefore to improve the powder yield.

The collection device may in particular contain, and/or be surrounded by, the fluid used to cool the powder.

Preferably, the distance between the energy source, preferably the flame (at its base) (for example the tip of the gun in the case of a spray device), and the collecting device is 1 to 2.5 m, preferably 1.3 to 2.2 m, for example 1.5 m or 2 m.

The process may comprise a step of selecting the particles of the powder collected as a function of their desired particle size, in particular by screening.

The process may comprise mixing the particles of thermoplastic polymer with the other optional components of the powder (in particular, the additives as described above), where appropriate.

Advantageously, the mixture is a dry mixture of the components of the powder, in pulverulent form. When the powder comprises more than two components, the mixing may be carried out in one step (all of the components being added to the mixture simultaneously) or in several steps (some components being premixed first before other components are added), it being possible for the components to be mixed in any order. The mixing may be carried out in any device suitable for mixing powders.

Alternatively, the additives, in full or in part, may be mixed with the thermoplastic polymer before the preparation of the thermoplastic polymer powder according to the invention, during the step of providing a thermoplastic polymer powder. Thus, in the case of manufacturing the powder by grinding, the additives may be mixed with the thermoplastic polymer before melting it or may be mixed with the ground thermoplastic polymer powder. If the powder is manufactured by dissolution/precipitation, the additives may be mixed with the thermoplastic polymer before it is dissolved in the solvent, or they may be mixed with the thermoplastic polymer after it has been dissolved in the solvent and before it is precipitated, or they may be mixed with the precipitated thermoplastic polymer powder. When only a portion of the additives are mixed with the thermoplastic polymer before the preparation of the powder according to the invention by heating by means of an energy source with a temperature of 600 to 10 000° C. (for example a flame), the remainder of the additives are mixed with said powder by dry mixing.

In some embodiments, at least one additive is added to the thermoplastic polymer powder prior to the heating step and the process comprises a step of spraying the powder. In these embodiments, the heating and spraying steps make it possible to encapsulate at least a portion of the powder particles with at least a portion of said additive. The encapsulation of the powder particles with an additive has the advantage of integrally binding the thermoplastic polymer and the additive, which makes it possible to reduce the segregation of the additive powder and maintain a homogeneous distribution of the additive in the powder. Encapsulation can also make it possible to reduce particle coalescence. In addition, when the additive is a fiber, encapsulation makes it possible to maintain the fibers in a random orientation, which gives isotropic properties to the powder.

### Process for Removing Fines

The invention also relates to a process for removing fines from a powder. The term “removing fines” is understood to mean reducing the amount of particles with a size of less than or equal to 30 μm, preferably less than 10 μm, in the powder. The amount of particles with a size of less than or equal to a given size in the powder can be determined by laser diffraction particle size analysis according to the standard ISO 13320:2009, for example on a Malvern Insitec® diffractometer.

This process according to the invention comprises the following steps:
a) providing a thermoplastic polymer powder;
b) heating said powder by means of an energy source with a temperature of from 600 to 10 000° C., preferably from 600 to 8000° C., more preferentially from 1000 to 3000° C.;
c) preferably, spraying the powder;
d) cooling the powder; and
e) collecting the powder.

What has been described in the previous section in relation to the process for preparing a thermoplastic polymer powder can be applied in the same way to this process.

In general, the higher the temperature of the energy source, the greater the reduction in the amount of particles with a size of less than or equal to 10 μm.

Advantageously, the process for removing fines allows a reduction in the amount of particles with a size of less than or equal to 20 μm and/or a reduction in the amount of particles with a size of less than or equal to 30 μm in the powder.

Advantageously, the collected powder contains a cumulative fraction of particles with a size of less than or equal to 10 μm of less than or equal to 1% by weight, preferably less than or equal to 0.8% by weight, relative to the total weight of the powder.

Advantageously, the powder contains a cumulative fraction of particles with a size of less than or equal to 30 μm of less than or equal to 10% by weight, preferably less than or equal to 5% by weight, more preferentially still less than or equal to 2% by weight, or less than or equal to 1% by weight, relative to the total weight of the powder.

Advantageously, the collected powder (i.e. the powder from which fines have been removed) is as described above in the “Powder” section and, in particular, has a Hausner ratio of less than or equal to 1.30 and comprises particles having a particle size distribution characterized by a span of greater than or equal to 1.0.

### Encapsulation Process

The invention also relates to a process for encapsulating thermoplastic polymer particles with at least one additive.

This process according to the invention comprises the following steps:
a) providing thermoplastic polymer particles;
b) mixing the thermoplastic polymer particles with at least one additive, so as to form a thermoplastic polymer powder;
c) heating said powder by means of an energy source with a temperature of from 600 to 10 000° C., preferably from 600 to 8000° C., more preferentially from 1000 to 3000° C.;
d) spraying the powder, where appropriate;
e) cooling the powder; and
f) collecting the powder.

The at least one additive is advantageously in pulverulent form. Preferably, it is chosen from the additives mentioned above in the preceding sections.

The thermoplastic polymer particles are preferably mixed with the at least one additive by dry mixing.

Preferably, the steps of heating and spraying are at least partly simultaneous.

What has been described in the previous section in relation to the process for preparing a thermoplastic polymer powder can be applied in the same way to this process. The step of providing thermoplastic polymer particles may be as described in the step of providing the thermoplastic polymer powder in the “Manufacturing processes” section above.

Advantageously, the collected powder (i.e. the encapsulated powder) is as described above in the “Powder” section and, in particular, has a Hausner ratio of less than or equal to 1.30 and comprises particles having a particle size distribution characterized by a span of greater than or equal to 1.0.

### Applications

The powder or composition as described above may be used in a process for constructing 3D articles, preferably layer-by-layer (also known as a 3D printing process), more preferentially by sintering, more preferentially still by electromagnetic radiation-mediated sintering, for example using infrared radiation, ultraviolet radiation, or preferably a laser.

Preferably, the composition of the invention is used in a selective laser sintering (SLS) process. The composition can also be used in a sintering process of the MJF (Multi Jet Fusion) and HSS (High Speed Sintering) type.

The invention also relates to a process for constructing a three-dimensional article, comprising:
a) depositing, preferably in the form of a layer, powder as described above or a composition as described above, in the form of a powder; and
b) sintering the powder, preferably by means of a beam of electromagnetic radiation.

Preferably, steps a) and b) are repeated to form the three-dimensional article.

The powder, as described above, can be recycled and reused in several successive builds. It may, for example, be used as is or as a mixture with other recycled or unrecycled powders. Advantageously, the non-agglomerated powder after step b), preferably after each step b) of the process, can be recycled into the same construction process, to carry out a subsequent deposition step a), or in another construction process.

What has been described above in relation to the use of the powder or composition for the construction of a three-dimensional article applies similarly to the process for constructing a three-dimensional article.

The invention also provides an article manufactured from a powder or a composition as described above, preferably by means of a process as described above.

In other embodiments, the powder or composition according to the invention may be used to coat a surface. The surface may be totally or partly coated.

Advantageously, the coating is a film obtained by melting the thermoplastic polymer powder described above or the composition described above in the form of a powder (in particular, a film that is 100 to 550 μm thick, more preferentially 200 to 500 μm thick).

The surface may be of any type, and in particular a metal surface, for example the surface of a part selected from the group consisting of ordinary or galvanized steel parts, aluminum parts or aluminum alloy parts.

The invention also provides a process for coating a surface, comprising the following steps:
bringing the surface into contact with the powder as described above or with the composition as described above, in the form of a powder;
melting the powder.

Before bringing the surface into contact with the powder, the coating process may comprise a step of applying a mask to the surface, in particular when the object to be coated must only be partially covered by the coating. The application of a mask makes it possible to selectively coat only certain portions of the part to be coated. The powder is then brought into contact with non-masked portions of the surface to be coated.

The powder may be applied to or placed in contact with a surface according to numerous coating techniques that are well known to those skilled in the art.

Preferably, the coating is performed via a method selected from the group consisting of fluidized bed dip coating, electrostatic spraying and hot powder-coating.

Thus, the coating may be performed by electrostatic spraying. The step of bringing the surface into contact with the powder or the composition in the form of a powder may then comprise the steps of:
electrically charging the powder;
spraying the electrically charged powder onto the surface;
heating the surface covered with the powder to a temperature above the melting temperature of the thermoplastic polymer.

Coating by electrostatic spraying consists in depositing electrostatically charged powder particles onto a surface, especially at ambient temperature. The powder may be electrostatically charged during its passage through the nozzle of spraying equipment. The powder thus charged can then be sprayed onto the object comprising the surface to be coated, which is connected to a zero potential. The coated object can then be placed in an oven at a temperature allowing melting of the powder.

The powder spraying equipment may be of any type. Preferably, the nozzle is brought to a high potential of between about 10 and about 100 kV, of negative or positive polarity. Preferentially, the powder spraying equipment is an electrostatic gun which charges the powder by the Corona effect and/or by triboelectrification.

Preferably, the powder flow rate in the spraying equipment is from 10 to 200 g/minute and more preferably from 50 to 120 g/minute. The electrostatic application temperature for the powder is preferably 15 to 25° C. The oven residence time for the surface is preferably 3 to 15 minutes. Advantageously, the heating temperature for the surface may be from 180 to 300° C., preferably 200 to 250° C. The heating temperature of the surface covered with powder may preferably be at least 30° C. above the melting temperature of the thermoplastic polymer, more preferably from 30 to 60° C. above the melting temperature of the thermoplastic polymer. The surface may then be cooled, for example to ambient temperature. If a mask was used, it can be removed.

Alternatively, the coating may be performed by fluidized-bed dip coating. Thus, the step of bringing the surface into contact with the powder may comprise the steps of:
heating the surface to a temperature above the melting temperature of the thermoplastic polymer;
dipping the surface into a fluidized bed comprising the powder.

The surface to be coated is preheated to a temperature allowing the melting of the powder according to the invention. The surface is then immersed in a fluidized bed comprising the powder. The powder melts on contact with the surface and forms a coating thereon. The coated surface is then preferably cooled, for example in the ambient air. When present, the mask can then be removed. Preferably, the fluidized air for the fluidization of the powder is cold, clean and free of oil. Preferably, the heating temperature for the surface is from 180 to 450° C., preferably 250 to 350° C.

More preferably, the heating of the surface is carried out at a temperature of at least 30° C. above the melting temperature of the thermoplastic polymer, more preferentially at a temperature 30 to 120° C. above the melting temperature of the thermoplastic polymer. Preferably, the duration of dipping of the surface in the fluidized bed is from 1 to 10 seconds, more preferentially from 3 to 7 seconds. The dipping of the surface in the fluidized bed may take place one or more times (each dipping preferably having a duration of from 1 to 10 s, more preferentially from 3 to 7 s).

In other embodiments, the coating is performed by hot powder-coating. The step of bringing the surface into contact with the powder then comprises the steps of:
heating the surface to a temperature above the melting temperature of the thermoplastic polymer;
spraying the powder onto the surface.

The surface heating temperature may be as described above in relation to the coating by fluidized-bed dip coating. It is especially preferably at least 30° C. above the melting temperature of the thermoplastic polymer, more preferentially from 30 to 120° C. above the melting temperature of the thermoplastic polymer. The surface may then be cooled, for example to ambient temperature. When a mask has been used, it can be removed. The sprayed powder may or may not be electrostatically charged.

The characteristics described above in relation to the use of the powder for coating a surface (in particular regarding the description of the surface and the thickness of the coating film) may apply in the same manner to the coating processes.

The invention also relates to an object having a surface covered at least partly with a coating obtained (or capable of being obtained) by melting a powder or composition as described above, preferably an object obtained (or capable of being obtained) by a process as described above.

Another subject of the invention relates to the use of the powder as described above or of a composition as described above, in the form of a powder, for manufacturing an article by rotational molding (also called rotomolding).

The invention also relates to a process for manufacturing an article, comprising the following steps:
providing a powder as described above or a composition as described above, in the form of a powder; and
rotationally molding said powder.

Rotational molding is a molding process in which the powder is introduced into a mold, which can be of varying size, shape, thickness and material. The mold is then heated while being rotated, which causes the powder to be heated, by conduction in contact with the mold wall, to its melting point. The total or partial rotation of the mold (advantageously at a speed of 2 to 40 rpm), preferably about one or two axes (which are preferably orthogonal), allows the molten material to cover the entire internal surface of the mold. The mold is then advantageously cooled, preferably with air or sprayed water, and preferably while being kept rotating. After the polymeric material has solidified, the article can be removed from the mold.

Advantageously, for the step of heating the mold, the mold is introduced into an oven. The mold is preferably heated to a temperature of 20° C. to 60° C. above the melting point of the polymer, preferably 20° C. to 40° C. above its melting point.

Rotational molding processes using polymer powder are well known to those skilled in the art.

The invention also provides an article obtained (or capable of being obtained) by a rotational molding process as described above.

### EXAMPLES

The following examples illustrate the invention without limiting it.

### Example 1

The following powders were prepared or used:
Powder 1: Pebax® 3533 commercial powder (Arkema).
Powder 2: Pebax® 40R53 commercial powder (Arkema).
Powder 3: Pebax® 4533 commercial powder (Arkema).
Powder 4: Rilsan® Fine Powders T BLUE 7443 commercial powder (Arkema).
Powder 5: Rilsan® Fine Powders T Nat BHV commercial powder (Arkema).
Powder 6: Orgasol® Invent SMOOTH commercial powder (Arkema).
Powder 7: PA2200 commercial powder (EOS).
Powder 8: Rilsan® Invent Natural commercial powder (Arkema).

Some of the powders 1, 2, 3, 4, 5 and 6 underwent the following treatment: the powders were pumped with air from a tank maintained under vibration and then transported to an IBEDA MiniSprayJet F311 FX oxy-propane flame sprayer (flame temperature 2000-2600° C.). The powders were then sprayed by means of the flame sprayer. The sprayed powders were collected in a cyclone-type recuperator where they were cooled by circulation of compressed air around the cyclone.

The following powders were obtained using the operating parameters indicated in the table below.

TABLE 1

| Powder treated | A | B | C | D | E | F |
|---|---|---|---|---|---|---|
| Starting powder | 1 | 2 | 2 | 3 | 4 | 5 |
| Powder pumping air pressure | 0.41 | 0.32 | 0.32 | 0.32 | 0.29 | 0.3 |
| (MPa) | | | | | | |
| Cooling air pressure (MPa) | 0.51 | 0.35 | 0.3 | 0.35 | 0.25 | 0.25 |
| Propane flow rate (l/min) | 17.5 | 17.5 | 17.5 | 17.5 | 21 | 21 |
| Dioxygen flow rate (l/min) | 24.5 | 42 | 53 | 42 | 53 | 53 |
| Sprayer gun - recuperator | 2 | 2 | 2 | 1.5 | 1.5 | 1.5 |
| distance (m) | | | | | | |

For all of the powder treatments, the inlet dry air pressure is 0.6 MPa, the propane pressure is 0.14 MPa, the dioxygen pressure is 0.25 MPa, the pipe for transporting the powder to the sprayer has an inner diameter (mm)/length (mm) ratio of 11/2000 and the carrier air pressure is 0 MPa, except for the treatment of powder 1 for which it is 0.04 MPa.

Powders 1, A, 2, B, C, 3 and D were then dry mixed with one or more flow agents in a Henschel IAM 6L mixerfor 100 s, at ambient temperature and with stirring at 9000 rpm. The flow agents and the amounts thereof (percentage by weight) are shown in the table below. The additivated powders are respectively referred to hereinafter as powders 1′, A′, 2′, B′, C′, 3′ and D′.

TABLE 2

| Powder | 1′ | A′ | 2′ | B′ | C′ | 3′ | D′ |
|---|---|---|---|---|---|---|---|
| Silica (CAB-O- | 0.2% | 0.2% | 0.3% | 0.3% | 0.3% | 0.5% | 0.5% |
| SIL ® TS610, | | | | | | | |
| from Cabot Corp) | | | | | | | |
| Wax (Crayvallac ® | — | — | — | — | — | 2.0% | 2.0% |
| WN-1265, from | | | | | | | |
| Arkema) | | | | | | | |

Powders A′, B′, C′, D′, E and F are powders according to the invention, powders 1′, 2′, 3′, 4, 5, 6, 7 and 8 are comparative powders.

The Hausner ratio and the span of the powders were then determined according to the methods described above.

The results are presented in the following table:

TABLE 3

| | Dv10 | Dv50 | Dv90 | | Hausner |
|---|---|---|---|---|---|
| Powder | (μm) | (μm) | (μm) | Span | Ratio |
| 1′ (CE) | 62 | 240 | 350 | 1.19 | 1.33 |
| A′ | 73 | 287 | 372 | 1.04 | 1.10 |
| 2′ (CE) | 36 | 84 | 144 | 1.28 | 1.32 |
| B′ | 46 | 93 | 154 | 1.16 | 1.26 |
| C′ | 48 | 96 | 154 | 1.1 | 1.20 |
| 3′ (CE) | 29 | 81 | 182 | 1.89 | 1.31 |
| D′ | 49 | 117 | 229 | 1.54 | 1.13 |
| 4 (CE) | 46 | 82 | 154 | 1.31 | 1.42 |
| E | 117 | 180 | 300 | 1.01 | 1.24 |
| 5 (CE) | 56 | 113 | 220 | 1.45 | 1.39 |
| F | 66 | 117 | 213 | 1.26 | 1.26 |
| 6 (CE) | 30 | 40 | 55 | 0.63 | 1.19 |
| 7 (CE) | 36 | 59 | 93 | 0.91 | 1.14 |
| 8 (CE) | 19 | 45 | 85 | 1.45 | 1.33 |

It was found that powders with a low Hausner ratio (i.e. high free flowability) combined with a high span were able to be obtained. In contrast, commercial powders 6 and 7 have a span of less than 1 and commercial powder 8 has a Hausner ratio of greater than 1.30.

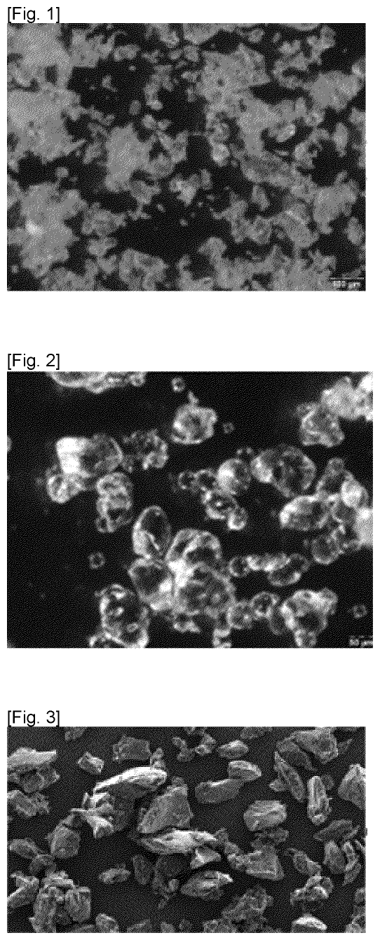

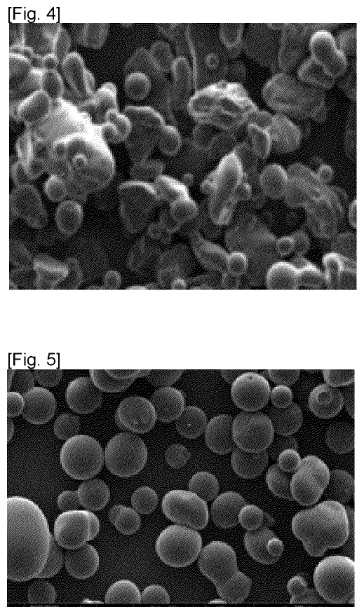

Micrographs of the particles of powders 1′, A′, 2′, B′ and C′ are shown in FIG. 1, FIG. 2, FIG. 3, FIG. 4 and FIG. 5 respectively. It is observed that the application of the powder treatment using the sprayer makes it possible to round, or even spheronize (in the case of powder C′), the particles of the ground powders.

### Example 2

Powders 3‘ and D’ as described in example 1 above were used to manufacture, by 3D printing by sintering, more specifically by SLS, 1 BA XY (in the build plane) test specimens according to the standard ISO 527, on a Sharebot SnowWhite machine, under the (powder and chamber) temperature conditions as indicated in table 4 below. The laser parameters used are the same for all of the printing operations and for each of the two powders tested, and are as follows: each layer of powder to be sintered is scanned by a 6.3 W power laser applied to the layer at points spaced apart by 0.06 mm at a speed of 40 000 points per second.

During the construction, the temperature of the powder at the surface of the build tank was set, and was measured at the surface by means of an infrared heat sensor. The temperature of the air in the chamber was measured by means of a temperature probe placed inside the machine, at less than 10 cm from the build tank.

The following properties of the test specimens thus constructed were then measured:
Density: measured by the Archimedean buoyancy force method described in the standard ISO 1183-1:2019; the average of the density of 5 test specimens was calculated.
Tensile modulus: measured on an Instron 5966 machine according to the standard ISO 527-2; the average of the tensile moduli of 5 test specimens was calculated.

A high density is a sign of good sintering of the powder particles together and of a successful transformation of the powder into a part.

The results are presented in table 4 below.

TABLE 4

| Powder | T° powder | T° chamber | | Tensile modulus |
|---|---|---|---|---|
| used | (° C.) | (° C.) | Density | (MPa) |
| 3′ (CE) | 118 | 95 | 0.91 | 56 |
| D′ | 118 | 95 | 0.99 | 68 |

The powder D′ according to the invention, having a lower Hausner ratio, enables the construction of parts having a better density and better mechanical properties.

The thermal stability of the powders 3′ and D′ was also evaluated. To this end, the powders were subjected to ageing in the following manner: for each of the powders, 100 successive layers were deposited using an EOS Formiga P100 machine, at a temperature of 125° C., without the use of a laser. For each of the powders, the tapped and untapped densities before and after ageing were measured. The delta density, corresponding to the difference between the density of the powder after ageing and the density of the powder ageing, was calculated.

The results are indicated in the table below.

TABLE 5

| | Untapped | Untapped | Tapped | Tapped | | |
|---|---|---|---|---|---|---|
| | density | density | density | density | Delta | Delta |
| | before | after | before | after | untapped | tapped |
| Powder | ageing | ageing | ageing | ageing | density | density |
| 3′ (CE) | 0.437 | 0.369 | 0.572 | 0.446 | −0.068 | −0.124 |
| D′ | 0.510 | 0.528 | 0.578 | 0.606 | +0.018 | +0.028 |

It is observed that the comparative powder loses density (untapped and tapped) after passing through the printing machine. Agglomeration of the powders and/or a loss of efficiency of the flow agent due to partial anchoring of this agent on the powder particles can explain this phenomenon.

In contrast, not only does the powder according to the invention not undergo any loss in density after passing through the printing machine, but it even has a higher untapped and tapped density. This powder will thus easily be able to be recycled in a new printing process.

### Example 3

A powder G was prepared by subjecting powder 8 described in example 1 to a treatment as described in example 1 (process according to the invention), but with the following operating parameters:
Powder pumping air pressure: 0.32 MPa;
Cooling air pressure: 0.35 MPa;
Propane flow rate: 17.5 l/min;
Dioxygen flow rate: 24.5 l/min;
Sprayer gun—recuperator distance: 2 m;
Carrier air pressure: MPa.

Particle size analysis of powders 1′, A′, 3′, D′, 4, E, 5, F and 8 described in example 1 and of powder G was performed by laser diffraction according to the standard ISO 13320:2009 on a Malvern Insitec® diffractometer. The cumulative fractions (as percentage) of particles of less than or equal to 5 μm, less than or equal to 10 μm, less than or equal to 20 μm and less than or equal to 30 μm are reported in the table below.

TABLE 6

| | Cumulative | Cumulative | Cumulative | Cumulative |
|---|---|---|---|---|
| | fraction <5 | fraction <10 | fraction <20 | fraction <30 |
| Powder | μm | μm | μm | μm |
| 1′ (CE) | 0.21% | 0.53% | 2.09% | 5.57% |
| A′ | <0.01% | <0.01% | 0.01% | 0.05% |
| 3′ (CE) | 1.89% | 3.71% | 8.33% | 15.17% |
| D′ | 0.36% | 0.46% | 0.56% | 0.77% |
| 5 (CE) | 0.28% | 0.31% | 0.58% | 1.63% |
| F | 0.27% | 0.28% | 0.36% | 0.83% |
| 8 (CE) | 1.18% | 3.19% | 10.92% | 23.40% |
| G | 0.59% | 0.64% | 0.93% | 1.52% |

It is found that the application of the process according to the invention makes it possible to reduce the amount of fine and very fine particles.

1. A thermoplastic polymer powder having a Hausner ratio of less than or equal to 1.30 and comprising particles having a particle size distribution characterized by a span of greater than or equal to 1.0.

2. The powder as claimed in claim 1, wherein the thermoplastic polymer is a semicrystalline thermoplastic polymer.

3. The powder as claimed in claim 1, wherein the thermoplastic polymer is chosen from the group consisting of polyamides, vinylidene fluoride homopolymers and copolymers, copolymers containing polyamide blocks and polyether blocks, thermoplastic polyurethanes, copolymers containing polyester blocks and polyether blocks, polycarbonate, polystyrene, polyaryl ether ketones, polyolefins, and combinations thereof.

4. The powder as claimed in claim 1, wherein the thermoplastic polymer is at least one polyamide and/or a copolymer containing polyamide blocks and polyether blocks.

5. The powder as claimed in claim 1, having a Hausner ratio of less than or equal to 1.28.

6. The powder as claimed in claim 1, comprising particles having a particle size distribution characterized by a span of 1.0 to 2.5.

7. The powder as claimed in claim 1, wherein the cumulative fraction of particles with a size of less than or equal to 10 μm is less than or equal to 1% by weight, relative to the total weight of the powder and/or the cumulative fraction of the particles with a size of less than or equal to 30 μm is less than or equal to 10% by weight, relative to the total weight of the powder.

8. The powder as claimed in claim 1, further comprising at least one additive chosen from the group consisting of flow agents, mineral fillers, fibers, polymer powders, dyes, pigments, fireproofing additives, antioxygen stabilizers, light stabilizers, impact modifiers, antistatic agents, flame retardants, and mixtures thereof.

9. A method comprising using a powder as claimed in claim 1 for constructing a three-dimensional article.

10. A method comprising using a powder as claimed in claim 1 for coating a surface.

11. A method comprising using a powder as claimed in claim 1 for manufacturing an article by rotational molding.

12. A process for preparing a thermoplastic polymer powder, comprising the following steps:
a) providing a thermoplastic polymer powder;
b) heating said powder by means of an energy source with a temperature of from 600 to 10,000° C.;
c) optionally, spraying the powder;
d) cooling the powder; and
e) collecting the powder.

13. The process as claimed in claim 12, wherein the powder prepared is a powder has a Hausner ratio of less than or equal to 1.30 and comprises particles having a particle size distribution characterized by a span of greater than or equal to 1.0.

14. The process as claimed in claim 12, wherein the step of providing the thermoplastic polymer powder comprises grinding the thermoplastic polymer, or dissolving the thermoplastic polymer in a solvent and precipitating said thermoplastic polymer from the solvent.

15. A process for encapsulating thermoplastic polymer particles with at least one additive, comprising the following steps:
a) providing thermoplastic polymer particles;
b) mixing the thermoplastic polymer particles with at least one additive chosen from the group consisting of flow agents, mineral fillers, fibers, polymer powders, dyes, pigments, fireproofing additives, antioxygen stabilizers, light stabilizers, impact modifiers, antistatic agents, flame retardants, and mixtures thereof, so as to form a thermoplastic polymer powder;
c) heating said powder by means of an energy source with a temperature of from 600 to 10,000° C.;
d) spraying the powder, where appropriate;
e) cooling the powder; and
f) collecting the powder.

16. The process as claimed in claim 15, wherein the step of providing thermoplastic polymer particles comprises grinding the thermoplastic polymer, or dissolving the thermoplastic polymer in a solvent and precipitating said thermoplastic polymer from the solvent.

17. The process as claimed in claim 12, wherein the cooling is carried out by bringing the powder into contact with a cold gas or cold water.

18. The process as claimed in claim 12, wherein the powder is collected in a recovery tank or in a cyclone.

19. The process as claimed in claim 12, further comprising a step of screening the collected powder and/or a step of mixing the collected, and optionally screened, powder with at least one additive.

20. A three-dimensional article manufactured from a powder as claimed in claim 1.
